(19) United States
(12) Patent Application Publication
(10) Pub. No.: US 2003/0066788 A1
(43) Pub. Date: Apr. 10, 2003

(54) Water quality management system

(76) Inventors: Jiahu Wang, Nepean (CA); Anthony C. Layden, Nepean (CA); Rajesh Jain, Ottawa (CA)

Correspondence Address: MARKS & CLERK, P.O. BOX 957, STATION B, OTTAWA, ON, K1P 5S7, CA

(21) Appl. No.: 09/969,603

(22) Filed: Oct. 4, 2001

(51) Int. Cl. C02F 1/00

(52) U.S. Cl. 210/85; 210/96.1

(57) ABSTRACT

A real-time water quality monitoring and action trigger system driven by an expert system for managing distributed and redundant water sources. The monitoring systems are installed at the water sources and real-time analysis is conducted at regular intervals and/or by triggering. The results are forwarded to a centralized quality control center via advanced data communications networks. The management center is equipped with a highly reliable computer system running water quality control expert system. Based on the field data, appropriate actions can be derived via applying the rules and/or models built in the expert system and proper triggers are sent to the treatment facilities at the water sources through data networks. The expert system is an open system that not only can learn and refine the rules and/or models but also incorporate new inputs from qualified personnel. The triggered actions include activating an appropriate water treatment, holding on the water supply pending on further treatment, or shutting down the water supply.

### FIELD OF THE INVENTION

The present invention relates to a real-time water quality monitoring and action triggering system and more particularly, the present invention relates to measurement, monitoring, analysis and action for dispatching at the remote water sources.

### BACKGROUND OF THE INVENTION

The current water management system has several noticeable shortcomings. First, it is difficult to ensure that the quality of the drinking water can always meet the regional drinking water standard since obtaining the quality data is time consuming. Water analysis involves several steps ranging from sampling of the water at the source and sending the sample to a laboratory for analysis. Once the results are available, they are communicated back to the local water management for actions such as effecting the treatment. This is a slow process and by the time the analysis shows any contamination, consumers could have been exposed to the danger for some time.

Another problem is realized in the limitations of knowledge and experience at the local management center to take timely and proper actions. In case treatment is required, it is also time consuming to find out whether the treatment is correct. Over treatment leads to waste of material and operational cost, but under-treatment is even more of a concern.

Further, the current water supply system is highly fragmented and not connected. The system is divided into small community-level and typically at the small community level and there is an insufficient number of well qualified personnel to take proper action during crisis and no backup water supply for consumers.

### SUMMARY OF THE INVENTION

One object of the present invention is to provide a water quality management system that can ensure that the quality of the water always meets the regional drinking water standard. This is achieved by combining a real-time quality analysis apparatus at the water source, a highly reliable, centralized quality control expert system and treatment equipment at the water source that can be triggered from the expert system. The analysis tools are installed at the water source and sampling and analysis can be done in real time on site.

A further object of an embodiment of the present invention is to provide a method of testing and monitoring water in a water system, comprising the steps of:

a) providing a network of individual water sources;

b) providing in the network, an analysis means for analyzing a water sample, a treatment means for treating water and central register interconnected to the analysis means and the treatment means;

c) sampling a water source;

d) comparing sample water data with known acceptable data in the central register;

e) treating, through instruction of the central register, with the treatment means the water source from an acceptable sample; and

f) monitoring, in real-time, treated water from step e).

The communication between the remote water source and the controlling center is via high performance data networks either wired or wireless. The center is equipped with an expert system that can trigger proper action based on the field data and rules (or models) stored in the expert system. The appropriate action is quickly dispatched to the treatment equipment and the progress of the action monitored by the analysis tools at the same location. The expert system keeps track of the progress of each action and makes modifications as required to achieve the desired results. Since a centralized control center can manage many water sources, the cost of the water management operation is greatly reduced. A center can operate 7 days a week and 24 hours per day and be staffed with highly qualified personnel. The distributed water supplies provide backups when one of the water supplies is not available due to contamination.

A convenient feature of the system is the real-time analysis at the water source. This allows for the immediate detection of water source conditions with contamination being uncovered quickly. The existing water quality control system requires the sampling, lab analysis and the communication of results from the lab to the water management station. This is time consuming and consumers may drink the contaminated water many days or even months before proper action is taken.

In accordance with another of object of one embodiment is to provide a system for testing and monitoring water in a water system, comprising:

a plurality of networked individual water sources;

analysis means for analyzing a source of water;

treatment means for effecting a necessary treatment of the water source;

a central register linked to the analysis means, treatment means and the water network and including information for effecting a predetermined action based on information provided from the water source, treatment means and analysis means; and

a network for connecting the treatment means, the central register and the individual water sources.

Advantageously, the system is centralized. The centralized center is well equipped with the computer system with enough data built in and can operate 24 hours. The centralized management also makes it easier to respond to new issues and implement new regulations.

Another aspect is the expert system that makes the routine monitoring and action handling very easy. It is also armed with an alarming system. The expert system is open and evolving through learning from both field data and human intervention.

A data network linking the remote water source and the control center is provided. The data network is highly redundant and this allows for the communication of triggering analysis to be sent to the real-time analysis tools at the remote site and the analysis results fed back to the center.

A further benefit of the system is the action triggering system allows for the saving, prompt action taking, new and improved actions/procedures being used. The result of this is rapid treatment. This not only ensures that the water our consumers drink is always of high quality, but also saves for the treatment cost such as the running cost of the treatment system, the treatment materials, etc.

Having thus described the invention, reference will now be made to the accompanying drawings illustrating preferred embodiments.

### BRIEF DESCRIPTION OF THE DRAWINGS

FIG. 1 is a schematic illustration of the system of the invention according to one embodiment;

FIG. 2 is a schematic illustration of distributed water sources and their connection to a treatment facility;

FIG. 3 is a schematic illustration of the interaction process of real-time monitoring at the water source, treatment equipment at the treatment facility and centralized control center;

FIG. 4 is a flow diagram for the decision-making and learning process via the expert system at the management center;

FIG. 5 is a schematic illustration of the alarming system of the central management system; and

FIG. 6 is a schematic illustration of data network for connecting the remote water sources, treatment sites and the redundant centralized control system.

Similar numerals in the figures denote similar elements.

### DETAILED DESCRIPTION OF THE PREFERRED EMBODIMENTS

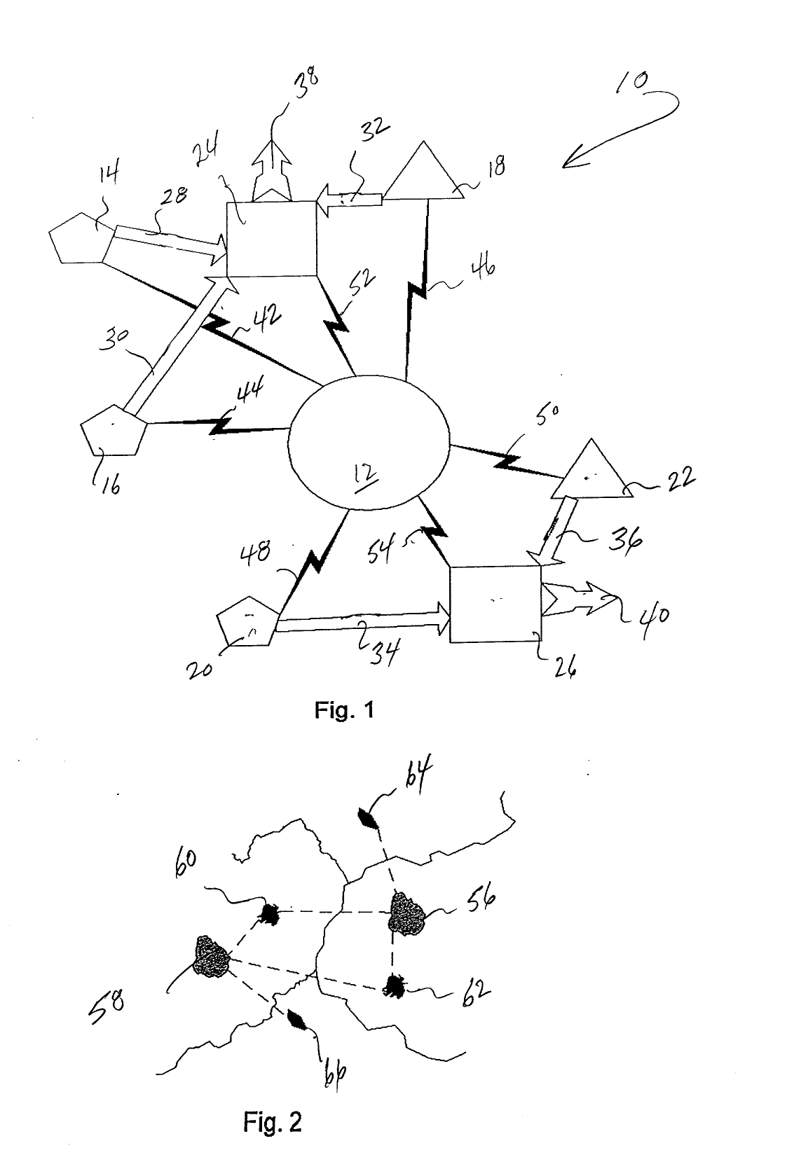

Referring now to FIG. 1, shown is a schematic view of the system globally referenced by numeral 10. The system consists of a centralized control center 12, a distributed water supply sources 14, 16, 18, 20 and 22 and water treatment sites. They can be either wells 14, 16, 20, lakes 18, 22 or river streams and located at different places around a community. Numerals 24 and 26 represent water treatment sites. These sites take water supplies from various sources. The control center 12, which is equipped with an expert computer system (not shown), manages the entire system including the water sources and treatment sites.

Conduits, 28, 30, 32, 34 and 36 take water from the supplies to the treatment sites. Depending upon the water quality at the sources, the control center 12 decides whether purification is required at the treatment center. When treatment is required, the expert system (not shown) can apply rules and/or models to determine the specifics of the purification and then trigger the appropriate treatment remotely. Once the treatment results are satisfactory, the water is released to the distribution channels via piper 38 and 40 to consumers in the served community. The communications between components in the system, i.e., between control center 12 and monitoring apparatus at water sources, treatment equipment or valves at treatment sites, is carried out via data networking paths 42, 44, 46, 48, 50, 52 and 54.

In operation, the monitoring apparatus installed at the water source obtains the quality parameters for the particular supply at regular interval and sends the results to the control center 12 via the data network. A computer system at the center 12 takes the quality data and makes inquiries to the expert system for decisions. This expert system is specially designed to efficiently manage water supply systems. It examines the data from the monitoring apparatus and applies rules or models built in to make decision of what actions need to be taken to ensure that the water can meet the regional drinking water standard. The appropriate trigger is chosen, dosage and duration and then via the data network, the center 12 sends this information to the treatment center. Accordingly, equipment at the treatment site is put to work. Progress of the purification is further monitored with apparatus installed at the treatment sites 22-24 and the results are fed back to the control center 12. The system uses the feedback to rectify the model or modify the model if the progress deviates from the prediction. As soon as the feedback indicates that the quality meets the standard, the control center 12 triggers to terminate the treatment.

The present invention employs redundant and distributed water supplied. FIG. 2 shows the distributed water sources for a large community. Connected to treatment site 58 are a well 66 and lakes 60 and 62. Redundant supplies are important because it ensures that the community can access to water when one of the source is not available due to heavy pollution. Drought may also lead to water levels being too low so alternative supplies are required. Geographically distributed water supplies can offer this redundancy. There are also economic benefits for having alternative water supplies. If the purification cost of one water supply is too high, the current system allows using an alternative supply to save cost. As shown in FIG. 2, the treatment site 58 can use lake 60 or 62 for water supply when well 66 is no longer a good or economical best source. The system also has options to take supplies from multiple sources and switch from one source to another. As mentioned earlier, the control of water source is carried out by the expert system located at the control center 12. Users of the current system define rules or criteria in the expert system for automatic selection of water sources.

For larger communities, more than one treatment site 56 and 58 in FIG. 2 may be deployed on top of multiple water supplied. These sites can share water sources 60 and 62 or use different sources 64 and 66.

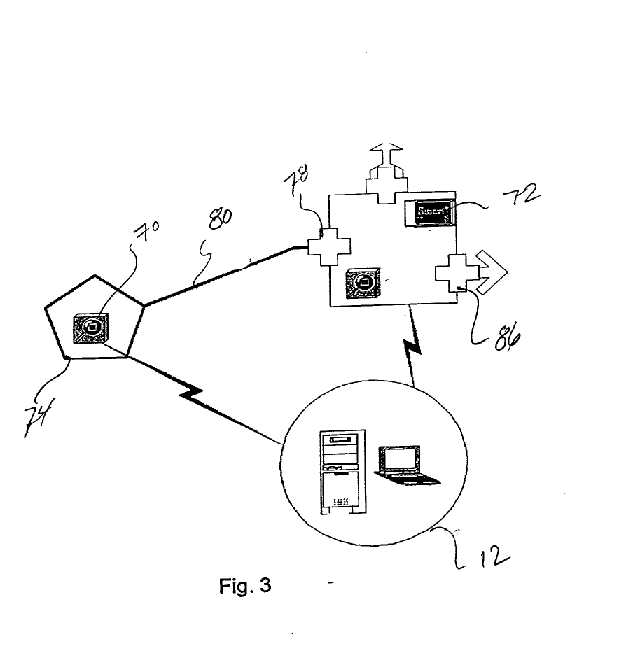

FIG. 3 shows the interactions between the control center 12 and the monitoring apparatus and the treatment equipment. Monitoring apparatus 70 and 82 are installed at both the water source 74 and treatment site 76. The monitoring devices chosen from the current system have real-time analysis capability. Data networks connecting the control center 12 and the monitoring devices facilitate exchange of information such as analysis results and triggering of a particular analysis. The system running at the control center 12 makes decisions based on the quality data obtained at the water source 74. If the water source is deemed as a suitable (treatable and economical) supply, the valve 78 is set to open position and the water is let in through the water pipe 80. The system determines the purification parameters based on the quality measurement at the source 74 and the models stored in the system. The control center 12 then sends the purification particulars to the treatment equipment 72 via data networks. The purification starts with the settings given by the control center 12 and the progress is checked against the models prediction. A monitoring device 82 at the treatment site carries out analysis when triggered by the control center 12 and reports the results. The control center 12 verifies the progress and makes changes to the treatment parameters if necessary. The tracking of the progress and the modeling capability of the system can predict when the treatment is sufficient. Once purification is done, water is released with valve 84 to the distribution channels for consumers (not shown). Therefore, the current system ensures that the treatment is started as soon as needed, but just as much as needed. Conveniently, this saves cost of treatment and avoids any excess treatment residues in the drinking water.

In the case that the treatment is found to be inefficient for the purification, or the treatment residues are too high, or an economically more favorable supply is available, the control center 12 may decide to terminate the purification process and drains the water at the treatment site through the valve 86. If a source is too polluted or no efficient treatment currently available for the contaminants, or too costly for treatment by the system after the quality analysis from the device at the water source, the control center 12 may temporarily shut down the water source by valve 78. Alternative supplies are brought in for the treatment site if this occurs as discussed in FIG. 2.

Since the quality monitoring is done on site and activated remotely, this saves time without the recourse of sending a person to the site for sampling and analysis of water. In case the present system is used to monitor remote lakes, river streams or ocean shores, the sites may not be always accessible easily. The monitoring devices at the treatment site also monitors the residues of the treatment as well as contents of remaining contaminant. The results can ensure that the treatment is not too much as the residues or purification chemicals may be harmful to human health.

At the center of the real-time monitoring and action trigger system is the water management expert system. The expert system is a rule based intelligent decision-making software. The built-in intelligence includes the accepted levels of chemical or biological elements in drinking water by various regional standards, all currently available real-time analysis devices, purification equipment and various generic models for efficient treatment of a wide range of different quality of water sources. The models are obtained based on the laboratory trials and the field data.

The operation of the water management expert system can be divided into adapting, learning, normal operation and manual enhancement steps. In the adapting a few steps, users of the expert system activate one or more standards as defined for the particular geographical region. The software also allows for a wide selection of industrially excepted real-time analysis methods and treatment procedures. The users of the system select the appropriate ones according to their particular development setup. The users also provide the software, the water source, the treatment site distribution and some associated costs of purification.

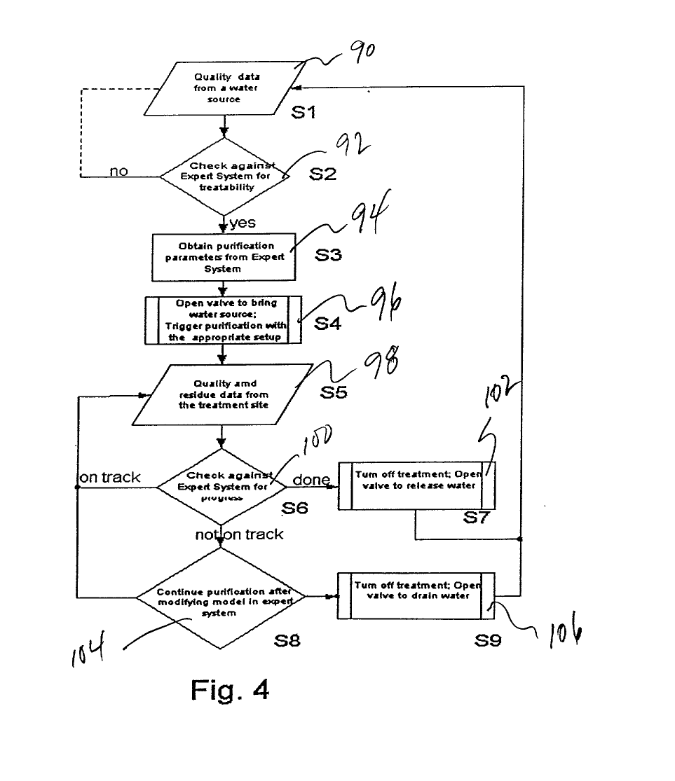

The learning and normal phases follow the same steps as shown in FIG. 4. The major difference is the different weight assigned to real data or the prediction of the chosen model. In the learning phase, more monitoring data are sampled for the progress in order to tailor the generic model for the site's particular setting. In the normal operation phase, the model's prediction power is heavily used for decisions of water sources treatability, purification costs and purification parameters.

The operation of the management system starts once the quality data of a water source are fed in 90. The data is check or compared against the threshold stored in the expert system and to decide whether the source is a suitable one ore not 92. The system can estimate the costs of purification. Depending on the rules setup by the user, if the source is found not treatable, the system goes back to check an alternative source or the same source at later time 90. If the source is deemed as a suitable one, the expert system determines the parameters for purification 94. It then activates the flow control to bring the water source to the treatment and triggers the purification process 96. As the purification proceeds, the control center triggers the monitoring devices at the treatment site to obtain real-time quality data and residue contents on a regular basis 98. The results are compared to the prediction based on models to verify the progress 100. If the quality data indicates that the contaminants are within the limits of regional standard and the residue level is acceptable, the control center triggers to turn off the treatment process and allows the water being release to the distribution channel 102. It then starts the entire process again by going back to 90. If the purification is not on track, the expert system decides with rules whether the treatment may be carried out better by modifying the model 104 or not. If the answer is yes, modified the model (learning) and the purification parameters are obtained and the treatment procedure is adjusted accordingly. If the system decides that modifying the treatment procedure will not help, it triggers to terminate the purification and drain the water 106. If the treatment process is found on track, this reinforces the model in the expert system. The expert system, based on the intelligence and the input data from the analysis, can predict what amount of treatment is required and for how long using a mathematical model. The system continues to monitor the progress by periodically sampling and analyzing the water quality until the completion of the purification.

The expert system used for the current system is an open system having two aspects. The system can incorporate new drinking water standards, new or enhanced monitoring methods, treatment procedures and new models. It also allows qualified personnel at the control center 12 to take actions for new situation. For example, if the quality monitoring device reveals that a new and unknown bio- or chemical material in the water source, the expert system allows a qualified personnel to respond immediately. In some situations, delays of actions by just a few days can be deadly.

Since the current system includes a centralized control system, the operation of many small water management sites is note required. Not only does this save operation cost, it also allows an easy implementation of new standards or procedures.

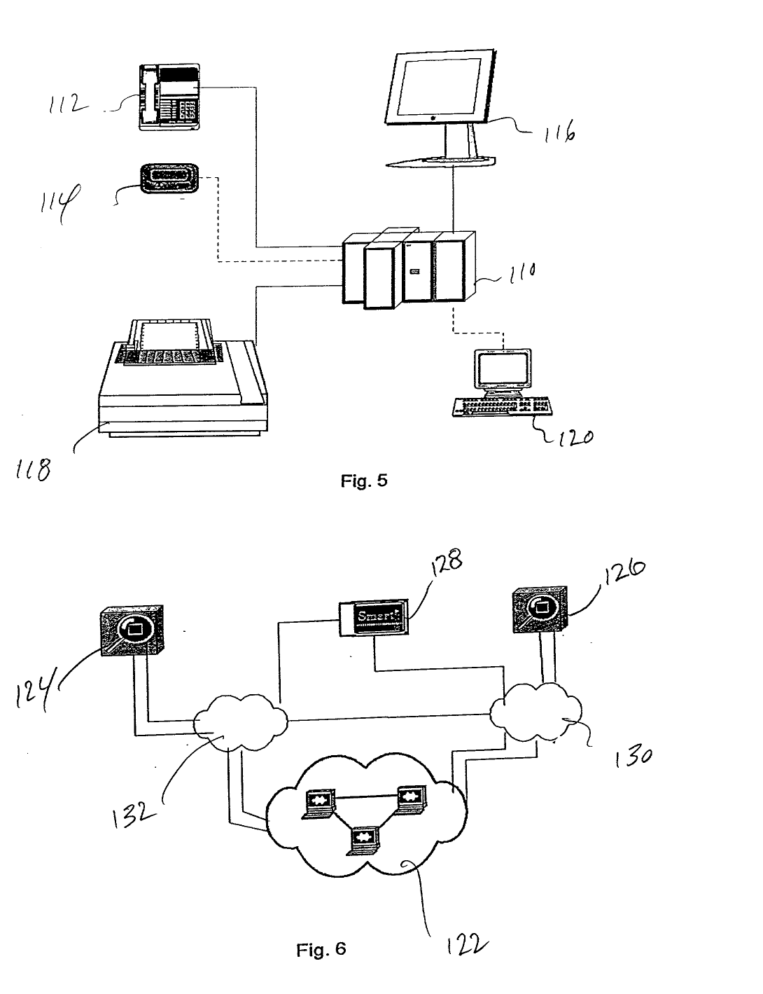

FIG. 5 illustrates the alarm system as part of the control system. The alarm conditions are manually defined from the expert system generally devoted by numeral 110 for all components of the systems and all stages of the water management system. As an example, if the contamination level of a water source is found to have abruptly changed, the control system sends out an alarm to trigger a telephone call 112 or a page 114 to the technical staff in the filed or at the control center. If the progress of purification falls short of the expectation, the control system may forward an alarm for immediate attention. Equipment breakdowns or loss of a communication path are conditions that lead to alarms and require human intervention.

Real-time water quality data is collected and projected on the larger screen 116. Different colors are used to indicate the treatment stages or water quality. For instance, the color green can be used to show that the water quality is good and yellow means that it meets most of the requirements but may require some treatments and red means that the treatment is required. Flashing red can indicate an alarming situation and immediate human intervention is needed. The results are constantly upgraded on the screen as new measurements are made available and more entries need to be displayed. An operator sitting in front of the screen can select any particular entry from the system for further information, such as each of the indicators that measured. For example, for a water source that being marked as yellow, the operator may choose to find out more information of which indicator or indicators are surpassed the acceptable levels and which actions have been triggered.

In addition, alarms are also thrown when a triggered purification fails to be effected. The alarm system either calls 112 or pages 114 the maintenance staff to correct the error. The alarm system may print the records of events 118 or forward the records to another computer system 120 processing. Statistical and correlation analysis of the alarm events are in turn used to enhance the management system.

FIG. 6 shows the redundant data networks and the highly reliable computer system for running the management expert system. Network adaptors (not shown) are installed on all the computer servers 122, monitoring devices 124, 126, purification equipment 128, and flow controls valves (not shown), etc. There are redundant network paths to reach every component of the system. The communication paths may be either wired based, wireless based or both and be either direct connections or via public wide area networks 130, 132. The intent of using redundant data networks is to ensure that data can be exchanged even when one of the communication path or means is not functional.

The servers for the control system are running in a cluster environment 122. Workloads are shared among the members and the computers appear as one large virtual server to the other components of the system. Inside the cluster, the resources are always used and there is no interruption of service due to fail-over. If one of the servers is unavailable, the other server or servers in the cluster continues to provide service for the water management system. The redundant nature of the servers and data communication paths guarantee that the control system can provide highly reliable services such as 99.999% of availability, similar to the public telephone system.

Although embodiments of the invention have been described above, it is not limited thereto and it will be apparent to those skilled in the art that numerous modifications form part of the present invention insofar as they do not depart from the spirit, nature and scope of the claimed and described invention.

I/we claim:

1. A method of testing and monitoring water in a water system, comprising the steps of:
a) providing a network of individual water sources;
b) providing in said network, an analysis means for analyzing a water sample, a treatment means for treating water and central register interconnected to said analysis means and said treatment means;
c) sampling a water source;
d) comparing sample water data with known acceptable data in said central register;
e) treating, through instruction of said central register, with said treatment means said water source from an acceptable sample; and
f) monitoring, in real-time, treated water from step e).

2. The method as set forth in claim 1, further including the step of transporting said water source to said treatment means.

3. The method as set forth in claim 1, further including the step of sampling water from a different source in said network of individual water sources when said data is unacceptable.

4. The method as set forth in claim 1, further including the step of purifying treated water.

5. The method as set forth in claim 4, further including the step of sampling purified water for comparison with said central register.

6. The method as set forth in claim 5, further including the step of releasing purified water to a distribution channel for consumption.

7. The method as set forth in claim 4, further including the step of discarding treated water at said treatment means through said central register.

8. The method as set forth in claim 1, further including the step of programming said central register with data.

9. A system for testing and monitoring water in a water system, comprising:
a plurality of networked individual water sources;
analysis means for analyzing a source of water;
treatment means for effecting a necessary treatment of said water source;
a central register linked to said analysis means, treatment means and said water network and including information for effecting a predetermined action based on information provided from said water source, treatment means and analysis means; and
a network for connecting said treatment means, said central register and said individual water sources.

10. The system as set forth in claim 9, wherein said system further includes an alarm system connected to said central register.

11. The method as set forth in claim 1, further including a purification apparatus.
